(19) United States
(12) Patent Application Publication
(10) Pub. No.: US 2026/0323574 A1
(43) Pub. Date: Oct. 15, 2026

(54) POSITIONING INTEGRITY TRANSMISSION METHODS, APPARATUS, DEVICE, AND MEDIUM

(71) Applicant: Beijing Xiaomi Mobile Software Co., Ltd., Beijing (CN)

(72) Inventor: Xiaolong LI, Beijing (CN)

(73) Assignee: Beijing Xiaomi Mobile Software Co., Ltd., Beijing (CN)

(21) Appl. No.: 19/122,440

(22) PCT Filed: Oct. 21, 2022
(86) PCT No.: PCT/CN2022/126685

§ 371 Date: Apr. 18, 2025

(51) Int. Cl. H04W 64/00

(52) U.S. Cl. CPC H04W 64/00

(57) ABSTRACT

Methods and apparatuses are disclosed for enhancing positioning integrity in wireless communication systems. In one aspect, a terminal transmits an error reason for positioning integrity, where the error reason includes error information that may cause the terminal to issue a positioning integrity alert, report a protection level (PL), or report both a PL and an achievable target integrity risk (TIR). The error information may include measurement or timing data, beam or antenna parameters, transmit/receive point (TRP) location data, and synchronization or beam characteristics of downlink positioning reference signals. In another aspect, a Location Management Function (LMF) network element may receive such error reasons from the terminal and utilize the information to modify the positioning method or optimize positioning configurations. Additionally, the terminal may receive error reasons generated by the LMF based on network-side analysis.

### CROSS REFERENCE TO RELATED APPLICATIONS

This application is a US National Phase of a PCT Application No. PCT/CN2022/126685 filed on Oct. 21, 2022, the entire contents of which are incorporated herein by reference in their entirety.

### TECHNICAL FIELD

The present disclosure relates to the field of mobile communication, particularly to transmission methods and apparatuses for positioning integrity, devices, and media.

### BACKGROUND

For positioning technology, the concept of positioning integrity has been introduced in New Radio (NR). The positioning integrity is the measure of confidence of the accuracy of position-related data provided by the positioning system, and is the measure of the ability to provide timely and effective alerts to LCS (Location Service) clients when the positioning system does not meet predetermined operating conditions.

At present, the positioning integrity for Assisting-Global Navigation Satellite System (A-GNSS) positioning technology has been standardized, mainly including the integrity parameters for error sources (assistance information) provided by the LMF (Location Management Function) network element to the UE (User Equipment). The UE implements positioning integrity based on the integrity parameters for the error sources and reports the positioning integrity result to the LMF network element, or the LMF network element determines the positioning integrity result of the UE based on the information of error sources.

### SUMMARY

The embodiments of the present disclosure provide transmission methods and apparatuses for positioning integrity, devices, and media. The technical solution is as follows.

According to one aspect of the present disclosure, a transmission method for positioning integrity is provided, performed by a terminal, including:
transmitting an error reason for positioning integrity, where the error reason includes error information.

According to one aspect of the present disclosure, a transmission method for positioning integrity is provided, performed by an LMF network element, including:
receiving an error reason for positioning integrity of a terminal, where the error reason includes error information.

According to one aspect of the present disclosure, a transmission method for positioning integrity is provided, performed by a terminal, including:
receiving an error reason for positioning integrity of the terminal transmitted by an LMF network element, where the error reason includes error information.

According to one aspect of the present disclosure, a transmission method for positioning integrity is provided, performed by an LMF network element, including:
transmitting an error reason for positioning integrity of a terminal, where the error reason includes error information.

According to another aspect of the present disclosure, a transmission apparatus for positioning integrity is provided, including:
a first transmitting module, configured to transmit an error reason for positioning integrity, where the error reason includes error information.

According to another aspect of the present disclosure, a transmission apparatus for positioning integrity is provided, including:
a second receiving module, configured to receive an error reason for positioning integrity of a terminal, where the error reason includes error information.

According to another aspect of the present disclosure, a transmission apparatus for positioning integrity is provided, including:
a third receiving module, configured to receive an error reason for positioning integrity of a terminal transmitted by an LMF network element, where the error reason includes error information.

According to another aspect of the present disclosure, a transmission apparatus for positioning integrity is provided, including:
a fourth transmitting module, configured to transmit an error reason for positioning integrity of a terminal, where the error reason includes error information.

According to another aspect of the present disclosure, a terminal is provided, including: one or more processors; a transceiver connected to the one or more processors; and one or more memories configured to store executable instructions that can be executed by the one or more processors; where the one or more processors are configured to load and execute executable instructions to implement the transmission method of positioning integrity as described in the above aspects.

According to another aspect of the present disclosure, a LMF network terminal is provided, including: one or more processors; a transceiver connected to the one or more processors; and one or more memories configured to store executable instructions that can be executed by the one or more processors; where the one or more processors are configured to load and execute executable instructions to implement the transmission method of positioning integrity as described in the above aspects.

According to another aspect of the present disclosure, a computer-readable storage medium is provided, where the computer-readable storage medium stores executable instructions, and the executable instructions are loaded and executed by one or more processors to implement the transmission method of positioning integrity as described above.

According to another aspect of the embodiments of the present disclosure, a chip is provided, including programmable logic circuits and/or program instructions for implementing a transmission method for positioning integrity as described above when the chip is run on a computer device.

According to another aspect of the present disclosure, a computer program product or computer program is provided, including computer instructions stored in one or more computer-readable storage media, and one or more processors read the computer instructions from the one or more computer-readable storage media and execute the computer instructions to implement the transmission method for positioning integrity described above.

The technical solutions provided in the embodiments of the present disclosure includes at least the following beneficial effects.

By reporting the error reason of the positioning integrity alert by the terminal in a scenario of terminal-based positioning integrity, the network device can be informed of the cause of the positioning integrity alert, such that the network device can reconfigure positioning parameters or use other positioning methods based on the error reason. In the scenario of LMF network element-based positioning integrity, the error reason causing the positioning integrity alert is transmitted by LMF to the terminal so that the terminal can be informed of the cause of the positioning integrity alert.

### BRIEF DESCRIPTION OF DRAWINGS

In order to more clearly illustrate the technical solutions according to the embodiments of the present disclosure, drawings that need to be used in the description of the embodiments will be briefly introduced below. The drawings in the following description only relate to some embodiments of the present disclosure. For those skilled in the art, other drawings can also be obtained based on these drawings without creative effort.

FIG. 1 is a schematic diagram of a communication system provided by an embodiment of the present disclosure.

FIG. 2 is a flowchart of a transmission method for positioning integrity provided by an embodiment of the present disclosure.

FIG. 3 is a flowchart of a transmission method for positioning integrity provided by an embodiment of the present disclosure.

FIG. 4 is a flowchart of a transmission method for positioning integrity provided by an embodiment of the present disclosure.

FIG. 5 is a flowchart of a transmission method for positioning integrity provided by an embodiment of the present disclosure.

FIG. 6 is a flowchart of a transmission method for positioning integrity provided by an embodiment of the present disclosure.

FIG. 7 is a flowchart of a transmission method for positioning integrity provided by an embodiment of the present disclosure.

FIG. 8 is a flowchart of a transmission method for positioning integrity provided by an embodiment of the present disclosure.

FIG. 9 is a flowchart of a transmission method for positioning integrity provided by an embodiment of the present disclosure.

FIG. 10 is a flowchart of a transmission method for positioning integrity provided by an embodiment of the present disclosure.

FIG. 11 is a flowchart of a transmission method for positioning integrity provided by an embodiment of the present disclosure.

FIG. 12 is a flowchart of a transmission method for positioning integrity provided by an embodiment of the present disclosure.

FIG. 13 is a flowchart of a transmission method for positioning integrity provided by an embodiment of the present disclosure.

FIG. 14 is a flowchart of a transmission method for positioning integrity provided by an embodiment of the present disclosure.

FIG. 15 is a flowchart of a transmission method for positioning integrity provided by an embodiment of the present disclosure.

FIG. 16 is a structural block diagram of a transmission apparatus for positioning integrity provided by an embodiment of the present disclosure.

FIG. 17 is a structural block diagram of a transmission apparatus for positioning integrity provided by an embodiment of the present disclosure.

FIG. 18 is a structural block diagram of a transmission apparatus for positioning integrity provided by an embodiment of the present disclosure.

FIG. 19 is a structural block diagram of a transmission apparatus for positioning integrity provided by an embodiment of the present disclosure.

FIG. 20 is a structural schematic diagram of a communication device provided in an embodiment of the present disclosure.

### DETAILED DESCRIPTION

To clarify purposes, technical solutions, and advantages of the embodiments of the present disclosure, further detailed descriptions of the embodiments of the present disclosure are provided below in conjunction with the accompanying drawings.

Embodiments will be described in detail here with the examples thereof expressed in the drawings. When the following descriptions involve the drawings, like numerals in different drawings represent like or similar elements unless stated otherwise. Embodiments described in the illustrative examples below are not intended to represent all embodiments consistent with the present disclosure. Rather, they are merely embodiments of devices and methods consistent with some aspects of the present disclosure as recited in the appended claims.

The term used in the present disclosure is for the purpose of describing particular examples only and is not intended to limit the present disclosure. As used in the present disclosure and the appended claims, the singular forms “a,” “an” and “the” are intended to include the plural forms as well, unless the context clearly indicates otherwise. It should also be understood that the term “and/or” as used herein refers to and includes any and all possible combinations of one or more of the associated listed items.

It should be understood that although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, the word “if” as used herein can be interpreted as “at the time of,” “when” or “in response to determining”.

Firstly, introduction will be given to the relevant technologies involved in the embodiments of the present disclosure.

For positioning technology, NR introduces the concept of positioning integrity. The positioning integrity is configured to measure the confidence of the accuracy of position related data provided by the positioning system, and measure the ability to provide timely and effective alerts to LCS (Location Service) clients when the positioning system does not meet predetermined operating conditions.

At present, the positioning integrity of A-GNSS positioning technology has been standardized, mainly including the integrity parameters for error sources (assistance information) provided by the LMF to the UE, where the integrity parameters include the parameters shown in table 1.

TABLE 1
Mapping of Integrity Parameters

| | | Integrity Fields | | | | |
|---|---|---|---|---|---|---|
| | GNSS | | Integrity | Integrity | | Integrity |
| | Assistance | Integrity | Bounds | Bounds | Residual | Correlation |
| Error | Data | Alerts | (Mean) | (StdDev) | Risks | times |
| Orbit | SSR | Real-Time | Mean Orbit | Variance | Probability | Orbit Range |
| | Orbit | Integrity | Error | Orbit Error | of Onset | Error |
| | Corrections | (see | Mean Orbit | Variance | of | Correlation |
| | | Claus. 1.8) | Rate Error | Orbit Rate | Constellation | time |
| | | | (Calculated | Error | Fault | Orbit Range |
| | | | according to | (Calculated | Probability | Rate Error |
| | | | Equation | according to | of Onset | Correlation |
| | | | 8.1.2.1.21-1) | Equation | of | time |
| | | | | 8.1.2.1.21-1) | Satellite | |
| Clock | SSR | | Mean Clock | Standard | Fault | Clock Range |
| | Clock | | Error | Deviation | Mean | Error |
| | Corrections | | Mean Clock | Clock Error | Constellation | Correlation |
| | | | Rate Error | Standard | Fault | time |
| | | | | Deviation | Duration | Clock Range |
| | | | | Clock Rate | Mean | Rate Error |
| | | | | Error | Satellite | Correlation |
| | | | | | Fault | time |
| Code | SSR | | Mean Code | Standard | Duration | |
| Bias | Code | | Bias Error | Deviation | | |
| | Bias | | Mean Code | Code Bias | | |
| | | | Bias Rate | Error | | |
| | | | Error | Standard | | |
| | | | | Deviation | | |
| | | | | Code Bias | | |
| | | | | Rate Error | | |
| Phase | SSR | | Mean Phase | Standard | | |
| Bias | Phase | | Bias Error | Deviation | | |
| | Bias | | Mean Phase | Phase Bias | | |
| | | | Bias Rate | Error | | |
| | | | Error | Standard | | |
| | | | | Deviation | | |
| | | | | Phase Bias | | |
| | | | | Rate Error | | |
| Ionosphere | SSR | Ionosphere | Mean | Standard | Probability | Ionosphere |
| | STEC | DNU | Ionospherre | Deviation | of Onset | Range Error |
| | Correction | | Error | Ionosphere | of | Correlation |
| | | | Mean | Error | Ionosphere | time |
| | | | Ionospherre | Standard | Fault | Ionosphere |
| | | | Rate Error | Deviation | Mean | Range Rate |
| | | | | Ionosphere | Ionosphere | Error |
| | | | | Rate Error | Fault | Correlation |
| | | | | | Duration | time |
| Troposphere | SSR | Troposphere | Mean | Standard | Probability | Troposphere |
| Vertical | Gridded | DNU | troposphere | Deviation | of Onset | Range Error |
| Hydro | Corrections | | Vertical | troposphere | of | Correlation |
| Static | | | Hydro Static | Vertical | troposphere | time |
| Delay | | | Delay Error | Hydro Static | Fault | Troposphere |
| | | | Mean | Delay Error | Mean | Range Rate |
| | | | troposphere | Standard | troposphere | Error |
| | | | Vertical | Deviation | Fault | Correlation |
| | | | Hydro Static | troposphere | Duration | time |
| | | | Delay Rate | Vertical | | |
| | | | Error | Hydro Static | | |
| | | | | Delay Rate | | |
| | | | | Error | | |
| TroposphereVertical | | | Mean | Standard | | |
| WetDelay | | | troposphere | Deviation | | |
| | | | Vertical Wet | troposphere | | |
| | | | Delay Error | Vertical Wet | | |
| | | | Mean | Delay Error | | |
| | | | troposphere | Standard | | |
| | | | Vertical Wet | Deviation | | |
| | | | Delay Rate | troposphere | | |
| | | | Error | Vertical Wet | | |
| | | | | Delay Rate | | |
| | | | | Error | | |

UE implements positioning integrity based on the above parameters and reports the result of positioning integrity to LMF.

In related arts, the positioning integrity issue of RAT-dependent (Radio Access technology-dependent) positioning technology is studied, such as UL-TDOA (Uplink time Difference of Arrival), DL-TDOA (Downlink time Difference of Arrival), UL-AOA (Uplink Angles of Arrival), DL-AOD (Downlink Angle-of-Departure), multi-RTT (Multiplecell-Round trip time) and other positioning technologies.

Where for downlink positioning technology, possible error source information includes:
position of TRP (Transmission/Reception Point);
time synchronization between TRPs (NR-RTD-Info, NR-Relative time Difference-Info, New Radio-Relative time Difference-Information);
Beam information of DL-PRS (DownLink-Positioning Reference Signal);
Boresight direction of DL-PRS;
Measurement of UE, such as RSTD (Reference Signal Time Difference), UE Rx-Tx timing difference;
timing of UE.

Where TRP can be also represented as an access network device. That is, the information of error sources can include at least one of: the position of the access network device, time synchronization between access network devices, beam information of DL-PRS, boresight direction of DL-PRS, measurement of UE, and timing of UE.

UE can calculate the positioning integrity based on the information of error sources and other parameters provided by the network device. When the PL calculated by the UE does not satisfy the following inequality, the UE reports the PL (protection level) to the LMF to provide an alert.

PL (Protection Level) refers to a statistical upper bound of Positioning Error (PE). PL needs to ensure that the probability per unit of time of the duration during which the true error is greater than the AL (Alert Limit) and the PL is less than or equal to the AL exceeding the TTA (Time-To-Alert) is less than the required TIR (Target Integrity Risk). That is, PL needs to satisfy the following inequality:
Prob per unit of time [((PE>AL) & (PL<=AL)) for longer than TTA]<required TIR
When the PL bounds the positioning error in the horizontal plane or on the vertical axis, then it is respectively called Horizontal Protection Level (HPL) or Vertical Protection Level (VPL).

Target Integrity Risk (TIR): the probability of a positioning error exceeding the Alert Limit (AL) without alerting the user within the required time-To-Alert (TTA). TIR is typically defined as the probability per unit of time (e.g., per hour, per second, or per independent time sample).

Alert Limit (AL): the maximum allowable positioning error that enables the positioning system to be used for the intended application. If the positioning error exceeds the range of the AL, the positioning system should be declared unusable in the intended application to prevent loss of positioning integrity. When AL limits positioning error on the horizontal plane or vertical axis, it is respectively referred to as Horizontal Alert Limit (HAL) or Vertical Alert Limit (VAL). Where the PL inequality is valid for all values of the AL.

TTA (Time-To-Alert): the maximum allowable time period from when a positioning error exceeds the alert limit (AL) to when the function providing positioning integrity transmits a corresponding alert.

Where TIR is configured by the LMF for the terminal. AL and TTA are determined by the terminal, such as obtained from a predetermined application. The terminal determines PL based on the above inequality and reports PL to the LMF network element.

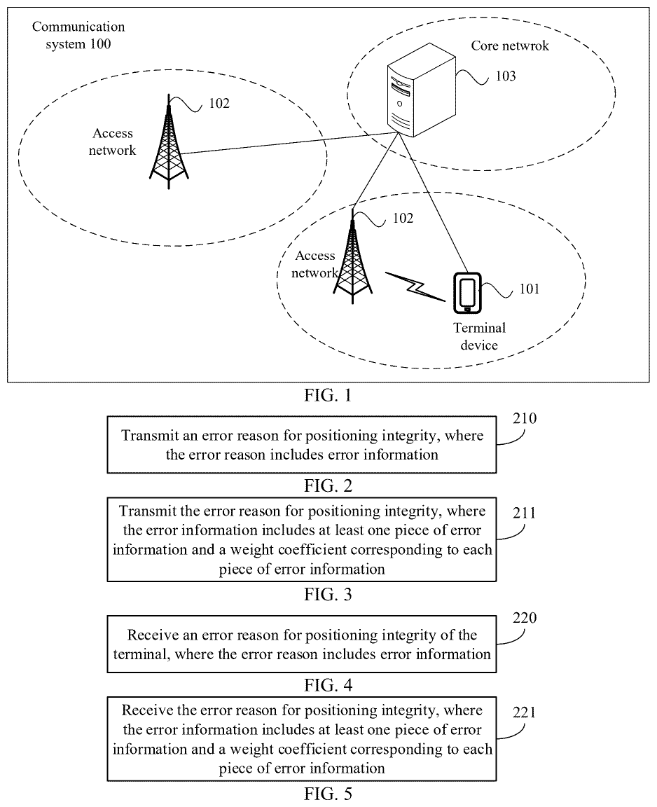

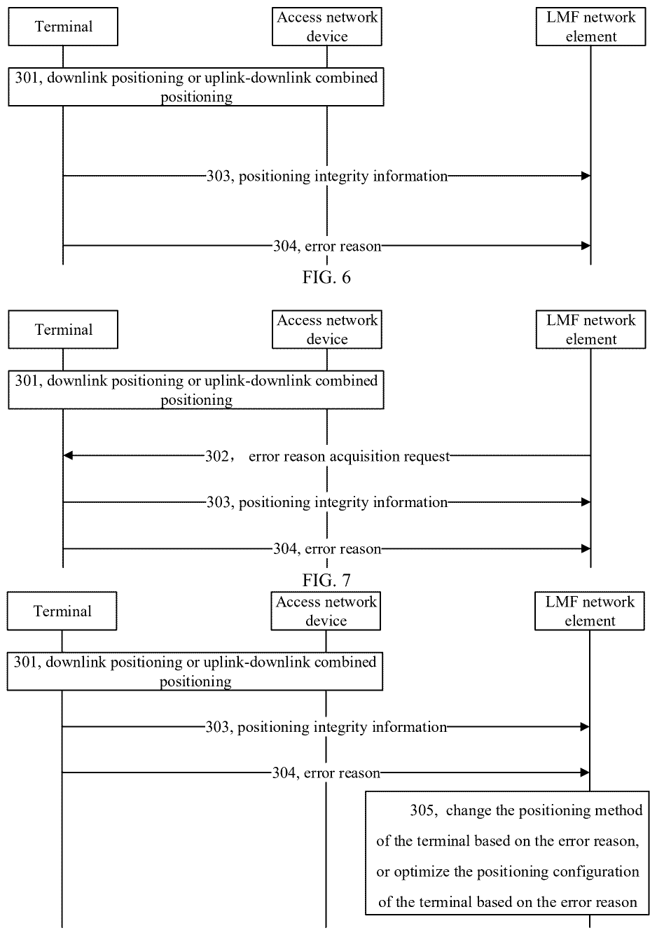

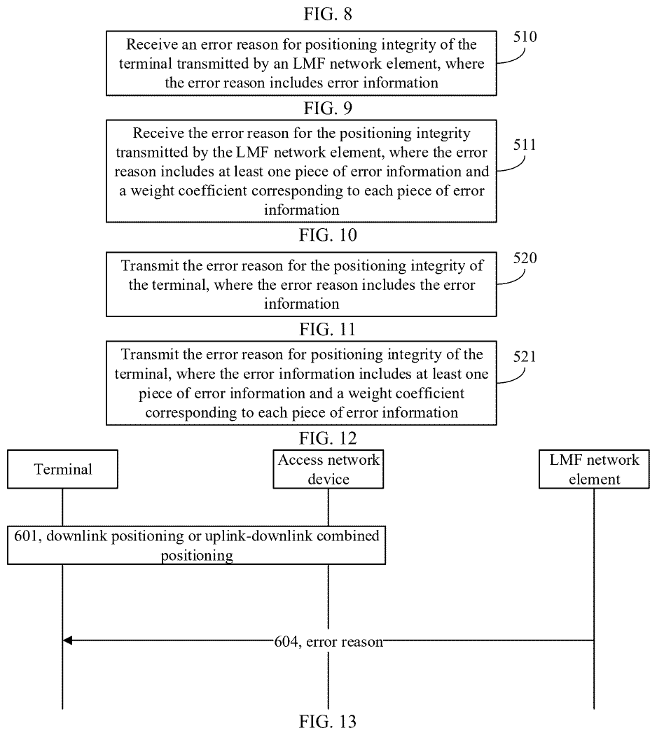

FIG. 1 is a schematic diagram of a communication system provided by an embodiment of the present disclosure. The communication system 100 may include: terminal(s) 101, access network device(s) 102, and core network device(s) 103.

There are usually multiple terminals 101, and one or more terminals 101 can be distributed within a cell managed by each access network device 102. The terminal 101 may include various handheld devices, in vehicle devices, wearable devices, computing devices, or other processing devices connected to wireless modems with wireless communication capabilities, as well as various forms of user equipment (UE), mobile stations (MS), and so on. For the convenience of description, in the embodiments of the present disclosure, the devices mentioned above are collectively referred to as terminals.

The access network device 102 is a device deployed in the access network to provide wireless communication functionality for the terminal 101. The access network device 102 can include various forms of macro base stations, micro base stations, relay stations, access points, and so on. In systems using different wireless access technologies, the names of devices with access network functionality may vary, such as gNodeB or gNB in the 5th Generation (5G) mobile communication technology NR system. With the evolution of communication technology, the name “access network device” may change. For the convenience of description in the embodiments of the present disclosure, the devices that provide wireless communication functionality for the terminal 101 are collectively referred to as the access network devices. The access network device 102 and the terminal 101 can establish a connection through an air interface for communication, including exchange of signaling and data. There can be multiple access network devices 102, and communication between two adjacent access network devices 102 can also be conducted through wired or wireless means. A terminal 101 can switch between different access network devices 102, i.e., establish connections with different access network devices 102. In some embodiments, the access network device has at least one TRP, and the access network device communicates with the terminal through the TRP.

The main functions of the core network device 103 are to provide user connections, manage users, and complete service bearer, serving as an interface between the bearer network and external networks. The access network device 102 and the core network device 103 can be collectively referred to as network devices. For example, the network device in the embodiments of the present disclosure can refer to the access network device. The core network device 103 and the access network device 102 communicate with each other through a certain technology, and a communication relationship can be established between the terminal 101 and the core network device 103 through the access network device 102. For example, the core network device in the embodiments of the present disclosure includes an LMF network element.

The “5G NR system” in the embodiments of the present disclosure can also be referred to as a 5G system or NR system, and those skilled in the art can understand the meaning. The technical solution described in the embodiments of the present disclosure can be applied to 5G NR systems, as well as to the subsequent evolution systems of 5G NR systems.

In some embodiments, positioning integrity includes terminal-based positioning integrity and LMF network element-based positioning integrity.
1. In the terminal-based positioning integrity, the LMF network element provides assistance information to the terminal to facilitate the calculation by the terminal of positioning integrity based on the assistance information.
2. In the LMF network element-based positioning integrity, the LMF network element can calculate the positioning integrity of the terminal through information provided by the terminal and/or the base station.

The present disclosure provides multiple exemplary embodiments for the two calculation methods of positioning integrity, to enable the non computing party (the LMF network element or the terminal) to know the reasons for the positioning integrity alert.

### 1. Terminal-Based Positioning Integrity.

FIG. 2 shows a flowchart of a transmission method for positioning integrity provided by an embodiment of the present disclosure. The method can be performed by the terminal. The method includes step S210.

In step 210, an error reason for positioning integrity is transmitted, where the error reason includes error information.

Positioning includes downlink positioning, uplink-downlink combined positioning, and uplink positioning. For example, the positioning technologies adopted include but are not limited to those based on DL-TDOA, DL-AOD, multi-RTT, UL-TDOA, or UL-AOA.

In some embodiments, the method provided in the embodiments of the present disclosure can be applied to downlink positioning or uplink-downlink combined positioning scenarios.

For downlink positioning or uplink-downlink combined positioning, the terminal transmits the error reason for positioning integrity to the LMF network element. In some embodiments, the UE reports the error reason to the LMF network element through an LPP (Long term Evolution Positioning Protocol) message. For example, the LPP message can be an LPP providing location information message.

In some embodiments, the positioning integrity includes at least one of the following:
The confidence of the accuracy of the location information provided by the positioning system;
The ability to transmit effective alerts when the positioning system does not meet the predetermined operating conditions.

Where the positioning system is a system that performs the above-mentioned positioning, such as one or more of the LMF network element (core network device), the terminal, or the access network device. Location information is information or data related to location or positioning. In some embodiments, failure to meet the predetermined operating conditions includes a Protection Level (PL) greater than an Alert Limit (AL).

In some embodiments, positioning integrity includes PL. PL includes HPL and/or VPL.

The positioning integrity is determined based on PE, TIR, AL, and TTA.

Where PE includes the distribution of positioning errors of the terminal. The specific acquisition method and data format of PE are implemented by the terminal. For example, PE includes the distribution of errors between the position obtained by the terminal through the positioning system over a period of time and the true position. The terminal can update the PE based on the new positioning results. For example, the terminal can obtain the positioning error information of the terminal from the application server to determine the PE of the terminal.

TIR is the probability that positioning error of the positioning system per unit of time exceeds AL. TIR can be configured by the LMF network element, determined by the terminal, or obtained by the terminal from an application server. For example, if the terminal transmits a TIR to the LMF, the terminal can obtain information from the application server to determine the TIR. For example, for UE based positioning integrity, LMF configures TIR for the terminal, indicating that the probability of the positioning error of positioning system of the terminal per unit of time exceeding AL should not exceed the TIR.

AL is the maximum allowable positioning error that enables the positioning system to be used for the intended application. AL is the maximum allowable positioning error that enables the positioning system to be used for a predetermined application (corresponding to the application server). AL is determined by the terminal, or obtained by the terminal from the application server. The application server sets AL according to the requirements of the predetermined application, such that the positioning error of the positioning system needs to be smaller than AL.

TTA is the maximum allowable time from the moment when the positioning error exceeds AL to the moment when the positioning system issues an alert. That is, the positioning system should issue an alert within TTA duration after the positioning error exceeds AL.

In some embodiments, PL is determined by the first inequality. The first inequality includes a first probability being less than TIR, where the first probability is the probability that the duration of the terminal satisfying both the first condition and the second condition is longer than TTA, the first condition includes PE being greater than AL, and the second condition includes PL being less than or equal to AL.

That is, the first inequality includes:
Prob per unit of time [((PE>AL) & (PL<=AL)) for longer than TTA]<required TIR

When the terminal determines that PL does not satisfy the above inequality, the terminal issues a positioning integrity alert to the network device or transmits PL to the network device. At this point, there is an error in the positioning integrity of the terminal. The terminal determines the error reason for positioning integrity and transmits the error reason to the network device (LMF network element). For example, the terminal determines the error information that causes the significant positioning error (PE).

In some embodiments, the error reason can include: error information. The error reason includes error information that causes the terminal to transmit the positioning integrity alert; or, the error reason includes the error information that causes the terminal to transmit PL; or the error reason includes the error information that causes the terminal to transmit PL and the Achievable target Integrity Risk (TIR).

In some embodiments, error information can also be referred to as error source information or a feared event. That is, error information can include error source information or a feared event.

Error information includes at least one of the following:
measurement information of the terminal;
timing information of the terminal;
a beam received by the terminal;
a receiving antenna of the terminal;
a position of TRP;
time synchronization information between TRPs (NR-RTD-Info);
beam information of a downlink positioning reference signal (DL-PRS); or
a boresight direction of a downlink positioning reference signal.

Where the measurement information of the terminal includes the relevant data obtained by the terminal measurement. The timing information of the terminal includes the local clock information of the terminal. The beam received by the terminal includes relevant information about the beam transmitted by the access network device to the terminal. The receiving antenna of the terminal includes relevant information about the antenna used by the terminal to receive positioning reference signals. TRP is the TRP of the access network device that jointly performs the positioning process with the terminal. When multiple TRPs are jointly performing the positioning process with the terminal, the error information may include time synchronization information between any two TRPs among the multiple TRPs. DL-PRS/PRS is a reference signal transmitted by the access network device (TRP) to the terminal for downlink positioning. The terminal receives and measures DL-PRS to obtain downlink positioning measurement result, and reports the downlink positioning measurement result to the network device (LMF network element) to complete the downlink positioning process.

Where the measurement information of the terminal includes at least one of the following:
a terminal receive-transmit timing difference (UE Rx-Tx timing difference);
Reference Signal time Difference (RSTD);
Positioning Reference Signal-Reference Signal Received Power (PRS-RSRP);
Positioning Reference Signal-Reference Signal Received Power Path (PRS-RSRPP);
Positioning Reference Signal-Reference Signal Received Quality (PRS-RSRQ); or
Positioning Reference Signal-Signal to Interference plus Noise Ratio (PRS-SINR).

Where PRS-RSRPP is the RSRP of the PRS transmission path. For example, the path for the downlink positioning reference signal to be transmitted from TRP to the terminal includes direct path, refracted path, etc.

Where TRP can also be represented as an access network device, and the error information can include at least one of the following: measurement information of the terminal, timing information of the terminal, beam received by the terminal, receiving antenna of the terminal, position of the access network device, time synchronization information between access network devices (NR-RTD-Info), beam information of the downlink positioning reference signal (DL-PRS), and boresight direction of the downlink positioning reference signal. In some embodiments, the error information can include any parameter information of the integrity parameters of the error sources shown in table 1.

In some embodiments, the error reason reported by the terminal can include at least one piece of error information. When the terminal detects multiple pieces of error information, each piece of error information corresponds to a weight coefficient, where the weight coefficient represents the contribution of the error information to the positioning integrity alert, PL, or achievable TIR.

FIG. 3 shows a flowchart of a transmission method for positioning integrity provided by an embodiment of the present disclosure. The method can be performed by the terminal. Based on the embodiment shown in FIG. 2, step 210 includes step 211.

In step 211, the error reason for positioning integrity is transmitted, where the error information includes at least one piece of error information and a weight coefficient corresponding to each piece of error information.

The terminal transmits an error reason for positioning integrity to the LMF network element, where the error information includes at least one piece of error information and a weight coefficient corresponding to each piece of error information.

When there are pieces of error information detected by the terminal, the error reason further includes: the weight coefficient corresponding to each piece of error information; where the weight coefficient is configured to represent a contribution of a piece of error information to a positioning integrity alert, or the weight coefficient is configured to represent a contribution of a piece of error information to a PL, or the weight coefficient is configured to represent a contribution of a piece of error information to an achievable TIR.

That is, the error reason reported by the terminal includes: at least one piece of error information and a weight coefficient corresponding to each piece of error information.

In some embodiments, the weight coefficient can be a coefficient calculated in real-time based on the contribution of error information to this positioning integrity alert. The weight coefficient can also be a preset weight coefficient based on the degree of impact of error information on the calculating of the positioning integrity.

In some embodiments, the error reason reported by the terminal can further include the specific numerical value corresponding to the error information. For example, when the error reason includes the measurement information of the terminal, the measurement value corresponding to the measurement information can also be carried in the error reason. Then, the error reason includes at least the error information. In addition, the error reason can further include at least one of: a weight coefficient corresponding to the error information or a specific numerical value corresponding to the error information.

In summary, the method provided in this embodiment enables the terminal to report the error reason causing the positioning integrity alert, and enables the network device to know the cause of the positioning integrity alert, such that the network device can reconfigure the positioning parameters or use other positioning methods based on the error reason.

FIG. 4 shows a flowchart of a transmission method for positioning integrity provided by an embodiment of the present disclosure. The method can be performed by the LMF network element. The method includes step 220.

In step 220, an error reason for positioning integrity of the terminal is received, where the error reason includes error information.

In the scenario of downlink positioning or uplink-downlink combined positioning, the LMF network element receives the error reason for the positioning integrity transmitted by the terminal.

In some embodiments, the LMF network element receives the error reason for positioning integrity through an LPP message. For example, the error reason is carried in the LPP provides location information.

In some embodiments, the positioning integrity includes at least one of the following:

The confidence of the accuracy of the location information provided by the positioning system; The ability to transmit effective alerts when the positioning system does not meet the predetermined operating conditions.

Where the positioning system is a system that performs the above-mentioned positioning, such as one or more of the LMF, the terminal, or the network device. Location information is information or data related to location or positioning. In some embodiments, failure to meet the predetermined operating conditions includes a Protection Level (PL) greater than an Alert Limit (AL).

In some embodiments, the positioning integrity includes at least one of the following:
The confidence of the accuracy of the location information provided by the positioning system;
The ability to transmit effective alerts when the positioning system does not meet the predetermined operating conditions.

Where the positioning system is a system that performs the above-mentioned positioning, such as one or more of the LMF network element (core network device), the terminal, or the access network device. Location information is information or data related to location or positioning. In some embodiments, failure to meet the predetermined operating conditions includes a Protection Level (PL) greater than an Alert Limit (AL).

In some embodiments, positioning integrity includes PL. PL includes HPL and/or VPL. The positioning integrity is determined based on PE, TIR, AL, and TTA.

In some embodiments, PL is determined by the first inequality. The first inequality includes a first probability being less than TIR, where the first probability is the probability that the duration of the terminal satisfying both the first condition and the second condition is longer than TTA, the first condition includes PE being greater than AL, and the second condition includes PL being less than or equal to AL.

That is, the first inequality includes:
Prob per unit of time [((PE>AL) & (PL<=AL)) for longer than TTA]<required TIR

When the terminal determines that PL does not satisfy the above inequality, the terminal issues a positioning integrity alert to the network device or transmits PL to the network device. At this point, there is an error in the positioning integrity of the terminal. The terminal determines the reason for the error in positioning integrity and transmits the error reason to the network device (LMF network element). For example, the terminal determines the error information that causes the significant positioning error (PE).

In some embodiments, the error reason includes: error information. The error reason includes error information that causes the terminal to transmit the positioning integrity alert; or the error reason includes the error information that causes the terminal to transmit PL; or the error reason includes the error information that causes the terminal to transmit PL and the Achievable target Integrity Risk (TIR).

In some embodiments, error information can also be referred to as error source information or a feared event. That is, error information can include error source information or a feared event.

Error information includes at least one of the following:
measurement information of the terminal;
timing information of the terminal;
a beam received by the terminal;
a receiving antenna of the terminal;
a position of TRP;
time synchronization information between TRPs (NR-RTD-Info);
beam information of a downlink positioning reference signal (DL-PRS); or
a boresight direction of a downlink positioning reference signal.

Where the measurement information of the terminal includes at least one of the following:
a terminal receive-transmit timing difference (UE Rx-Tx timing difference);
RSTD;
PRS-RSRP;
PRS-RSRPP;
PRS-RSRQ; or
PRS-SINR.

Where TRP can also be represented as an access network device, and the error information can include at least one of the following: measurement information of the terminal, timing information of the terminal, beam received by the terminal, receiving antenna of the terminal, position of the access network device, time synchronization information between access network devices (NR-RTD-Info), beam information of the downlink positioning reference signal (DL-PRS), and boresight direction of the downlink positioning reference signal.

In some embodiments, the error information can include any parameter information of the integrity parameters of the error sources shown in table 1.

In some embodiments, the reason for the error reported by the terminal can include at least one piece of error information. When the terminal detects multiple pieces of error information, each piece of error information corresponds to a weight coefficient, where the weight coefficient represents the contribution of the error information to the positioning integrity alert, PL, or achievable TIR.

FIG. 5 shows a flowchart of a transmission method for positioning integrity provided by an embodiment of the present disclosure. The method can be performed by the LMF network element. Based on the embodiment shown in FIG. 4, step 220 includes step 221.

In step 221, the error reason for positioning integrity is received, where the error information includes at least one piece of error information and a weight coefficient corresponding to each piece of error information.

The LMF network element receives an error reason for positioning integrity transmitted by the terminal, where the error information includes at least one piece of error information and a weight coefficient corresponding to each piece of error information.

When there are pieces of detected error information, the error reason further includes: the weight coefficient corresponding to each piece of error information; where the weight coefficient is configured to represent a contribution of a piece of error information to a positioning integrity alert, or the weight coefficient is configured to represent a contribution of a piece of error information to a PL, or the weight coefficient is configured to represent a contribution of a piece of error information to an achievable TIR.

That is, the error reason reported by the terminal includes: at least one piece of error information and a weight coefficient corresponding to each piece of error information.

In some embodiments, the weight coefficient can be a coefficient calculated in real-time based on the contribution of error information to this positioning integrity alert. The weight coefficient can also be a preset weight coefficient based on the degree of impact of error information on the calculation of positioning integrity.

In some embodiments, the reason for the error reported by the terminal can further include the specific numerical value corresponding to the error information. For example, when the error reason includes the measurement information of the terminal, the measurement value corresponding to the measurement information can also be carried in the error reason. Then, the error reason includes at least the error information. In addition, the error reason can further include at least one of: a weight coefficient corresponding to the error information or a specific numerical value corresponding to the error information.

In some embodiments, before step 210 or step 211, the terminal can receive assistance information transmitted by the LMF network element, and the positioning integrity of the terminal can be calculated based on the assistance information. If the positioning integrity alert of the terminal is determined, the error reason for the positioning integrity of the terminal is further determined, in order to transmit the positioning integrity alert and error reason to the LMF network element.

In summary, the method provided in this embodiment enables the terminal to report the error reason causing the positioning integrity alert, and enables the network device to know the cause of the positioning integrity alert, such that the network device can reconfigure the positioning parameters or use other positioning methods based on the error reason.

FIG. 6 shows a flowchart of a transmission method for positioning integrity provided by an embodiment of the present disclosure. This method can be performed by the terminal, the access network device, and the LMF network element. The method includes step 301, 303 and 304.

In step 301, the terminal and the access network device perform downlink positioning or uplink-downlink combined positioning.

In some embodiments, during the process of performing downlink positioning or combining uplink and downlink positioning, the access network device (TRP) transmits a PRS to the terminal, and the terminal receives and measures the PRS to obtain the downlink positioning measurement result. Further, the terminal calculates the positioning integrity based on the downlink positioning measurement result.

In step 303, the terminal transmits positioning integrity information to the LMF network element.

In some embodiments, the terminal can report positioning integrity information to the LMF network element in real-time. That is, regardless of whether PL satisfies the inequality mentioned above, the terminal will report positioning integrity information to the LMF network element. Alternatively, the terminal may only report positioning integrity information to the LMF network element when a positioning integrity alert is generated or when PL does not satisfy the inequality mentioned above.

In some embodiments, positioning integrity information includes PL, or positioning integrity includes PL and achievable TIR. In some embodiments, when the positioning integrity is incorrect or the PL does not satisfy the inequality described earlier, the positioning integrity information includes a positioning integrity alert, or PL, or PL and achievable TIR, where PL is the PL that does not satisfy the inequality mentioned above.

In some embodiments, the positioning integrity information is carried in the LPP message. That is, the terminal transmits an LPP message to the LMF network element, where the LPP message carries positioning integrity information. The LMF network element receives the LPP message and reads the positioning integrity information from the LPP message.

In step 304, the terminal transmits the error reason for positioning integrity to the LMF network element.

When there is a positioning integrity error, or when PL does not satisfy the inequality, or when a positioning integrity alert is generated, the terminal reports the error information for positioning integrity to the LMF network element.

Where the detected error information is the error information that causes the UE to transmit a positioning integrity alert or the error information that causes the UE to transmit PL.

That is, the error reason includes: error information. The error reason includes error information that causes the terminal to transmit the positioning integrity alert; or, the error reason includes the error information that causes the terminal to transmit PL; or the error reason includes the error information that causes the terminal to transmit PL and the Achievable target Integrity Risk (TIR).

Error information includes at least one of the following:
measurement information of the terminal;
timing information of the terminal;
a beam received by the terminal;
a receiving antenna of the terminal;
a position of TRP;
time synchronization information between TRPs (NR-RTD-Info);
beam information of a downlink positioning reference signal (DL-PRS); or
a boresight direction of a downlink positioning reference signal.

Where the measurement information of the terminal includes at least one of the following:
a terminal receive-transmit timing difference (UE Rx-Tx timing difference);
RSTD;
PRS-RSRP;
PRS-RSRPP;
PRS-RSRQ; or
PRS-SINR.

Where TRP can also be represented as an access network device, and the error information can include at least one of the following: measurement information of the terminal, timing information of the terminal, beam received by the terminal, receiving antenna of the terminal, position of the access network device, time synchronization information between access network devices (NR-RTD-Info), beam information of the downlink positioning reference signal (DL-PRS), and boresight direction of the downlink positioning reference signal.

In some embodiments, the error reason for positioning integrity is carried in the LPP message, such as in the message of the LPP provide location information. The terminal transmits an LPP message to the LMF network element, where the LPP message includes the error reason for the positioning integrity; and the LMF network element receives LPP message and reads the error reason for positioning integrity.

In some embodiments, steps 301, 303, and 304 can be implemented separately as one embodiment, or any of steps 301, 303, and 304 can be recombined into a new embodiment.

In summary, the method provided in this embodiment allows the UE to report not only the positioning integrity alert or PL to the LMF network element when a positioning integrity alert occurs or PL does not satisfy the inequality in the scenario of downlink positioning or uplink-downlink combined positioning. In addition, the UE further reports the error reason for the positioning integrity to the LMF network element, informing the LMF network element of the cause of the positioning integrity alert or transmitting PL, which facilitates the LMF network element to adjust the positioning technology based on the error reason or optimize the positioning configuration through the error reason.

FIG. 7 shows a flowchart of a transmission method for positioning integrity provided by an embodiment of the present disclosure. This method can be performed by the terminal, the access network device, and the LMF network element. The method includes step 301, 302, 303 and 304.

In step 301, the terminal and the access network device perform downlink positioning or uplink-downlink combined positioning.

The access network device transmits a downlink positioning signal, and the terminal receives and measures the downlink positioning signal to obtain the positioning measurement result. The terminal reports positioning integrity information to the LMF network element.

In some embodiments, positioning integrity information can be carried in the LPP message.

In step 302, the LMF network element transmits an error reason acquisition request to the terminal.

In some embodiments, the LMF network element can transmit a request to the terminal to obtain the reason for the error, requesting the error information that triggers the positioning integrity alert.

In some embodiments, the error reason acquisition request is carried in the LPP message. For example, the LPP message can be a message about an LPP request for location information.

The LMF network element transmits an LPP message to the terminal, where the LPP message includes a request to obtain the error reason; and the terminal receives the LPP message transmitted by the LMF network element and reads the error reason to obtain the request.

In step 303, the terminal transmits positioning integrity information to the LMF network element.

The terminal calculates the positioning integrity information based on the positioning measurement result and reports the positioning integrity information to the LMF network element.

In some embodiments, the positioning integrity information includes at least one of: positioning integrity alert; PL; or PL and achievable TIR. When PL does not satisfy the inequality, the terminal can transmit a positioning integrity alert to the LMF network element, or transmit PL to the LMF network element, or transmit PL and achievable TIR to the LMF network element.

In some embodiments, the positioning integrity information is carried in the LPP message. For example, the terminal transmits an LPP message to an LMF network element, where the LPP message carries the positioning integrity information; the LMF network element receives LPP message and reads the positioning integrity information from the LPP message.

In step 304, the terminal transmits the error reason for positioning integrity to the LMF network element.

In some embodiments, the terminal responds to the error reason acquisition request and reports the error reason of the detected positioning integrity to the LMF network element, where the error reason includes the detected error information.

Where the detected error information is the error information that causes the UE to transmit a positioning integrity alert or the error information that causes the UE to transmit PL.

That is, the error reason includes: error information. The error reason includes error information that causes the terminal to transmit the positioning integrity alert; or the error reason includes the error information that causes the terminal to transmit PL; or the error reason includes the error information that causes the terminal to transmit PL and the Achievable target Integrity Risk (TIR).

Error information includes at least one of the following:
measurement information of the terminal;
timing information of the terminal;
a beam received by the terminal;
a receiving antenna of the terminal;
a position of TRP;
time synchronization information between TRPs (NR-RTD-Info);
beam information of a downlink positioning reference signal (DL-PRS); or
a boresight direction of a downlink positioning reference signal.

Where the measurement information of the terminal includes at least one of the following:
a terminal receive-transmit timing difference (UE Rx-Tx timing difference);
RSTD;
PRS-RSRP;
PRS-RSRPP;
PRS-RSRQ; or
PRS-SINR.

Where TRP can also be represented as an access network device, and the error information can include at least one of the following: measurement information of the terminal, timing information of the terminal, beam received by the terminal, receiving antenna of the terminal, position of the access network device, time synchronization information between access network devices (NR-RTD-Info), beam information of the downlink positioning reference signal (DL-PRS), and boresight direction of the downlink positioning reference signal.

In some embodiments, the error reason for positioning integrity is carried in the LPP message, such as in the message of the LPP provide location information. The terminal transmits an LPP message to the LMF network element, where the LPP message includes the error reason for the positioning integrity; and the LMF network element receives LPP message and reads the error reason for positioning integrity.

In some embodiments, steps 303 and 304 can be executed simultaneously or separately. When executed simultaneously, the integrity information and error reason can be carried in the same message. For example, the terminal transmits an LPP message to the LMF network element, where the LPP message includes positioning integrity information and the error reason. When step 303 and step 304 are executed separately, the order in which the two steps are executed is not limited.

In some embodiments, steps 301, 302, 303, and 304 can be implemented separately as one embodiment, or any of steps 301, 302, 303, and 304 can be recombined into a new embodiment.

In summary, the method provided in this embodiment allows the UE to report not only the positioning integrity alert or PL to the LMF network element when a positioning integrity alert occurs or PL does not satisfy the inequality in the scenario of downlink positioning or uplink-downlink combined positioning. In addition, the UE can respond to the error reason acquisition request transmitted by the LMF network element to report the error reason for the positioning integrity to the LMF network element, informing the LMF network element of the cause of the positioning integrity alert or transmitting PL, which facilitates the LMF network element to adjust the positioning technology based on the error reason or optimize the positioning configuration through the error reason.

FIG. 8 shows a flowchart of a transmission method for positioning integrity provided by an embodiment of the present disclosure. This method can be performed by the terminal, the access network device, and the LMF network element. The method includes step 301, 303, 304 and 305.

In step 301, the terminal and the access network device perform downlink positioning or uplink-downlink combined positioning.

The access network device transmits a downlink positioning signal, and the terminal receives and measures the downlink positioning signal to obtain the positioning measurement result. The terminal reports positioning integrity information to the LMF network element.

In some embodiments, positioning integrity information can be carried in the LPP message.

In step 303, the terminal transmits positioning integrity information to the LMF network element.

The terminal calculates the positioning integrity information based on the positioning measurement result and reports the positioning integrity information to the LMF network element. The LMF network element receives the positioning integrity information reported by the terminal.

In some embodiments, the positioning integrity information includes at least one of: positioning integrity alert; PL; or PL and achievable TIR. When PL does not satisfy the inequality, the terminal can transmit a positioning integrity alert to the LMF network element, or transmit PL to the LMF network element, or transmit PL and achievable TIR to the LMF network element.

In some embodiments, the positioning integrity information is carried in the LPP message. For example, the terminal transmits an LPP message to an LMF network element, where the LPP message carries the positioning integrity information; the LMF network element receives LPP message and reads the positioning integrity information from the LPP message.

In step 304, the terminal transmits the error reason for positioning integrity to the LMF network element.

In some embodiments, the terminal can actively report the error reason for positioning integrity to the LMF network element when a positioning integrity alert occurs; and the terminal can further respond to the error reason acquisition request transmitted by the LMF network element and report the detected error reason for positioning integrity to the LMF network element, where the error reason includes the detected error information.

Where the detected error information is the error information that causes the UE to transmit a positioning integrity alert, or the error information that causes the UE to transmit a PL, or the error information that causes the UE to transmit a PL and achievable TIR.

That is, the error reason includes: error information. The error reason includes error information that causes the terminal to transmit the positioning integrity alert; or, the error reason includes the error information that causes the terminal to transmit PL; or the error reason includes the error information that causes the terminal to transmit PL and the Achievable target Integrity Risk (TIR).

Error information includes at least one of the following:
measurement information of the terminal;
timing information of the terminal;
a beam received by the terminal;
a receiving antenna of the terminal;
a position of TRP;
time synchronization information between TRPs (NR-RTD-Info);
beam information of a downlink positioning reference signal (DL-PRS); or
a boresight direction of a downlink positioning reference signal.

Where the measurement information of the terminal includes at least one of the following:
a terminal receive-transmit timing difference (UE Rx-Tx timing difference);
RSTD;
PRS-RSRP;
PRS-RSRPP;
PRS-RSRQ; or
PRS-SINR.

Where TRP can also be represented as an access network device, and the error information can include at least one of the following: measurement information of the terminal, timing information of the terminal, beam received by the terminal, receiving antenna of the terminal, position of the access network device, time synchronization information between access network devices (NR-RTD-Info), beam information of the downlink positioning reference signal (DL-PRS), and boresight direction of the downlink positioning reference signal.

In some embodiments, the error reason for positioning integrity is carried in the LPP message, such as in the message of the LPP provide location information. The terminal transmits an LPP message to the LMF network element, where the LPP message includes the error reason for the positioning integrity; and the LMF network element receives LPP message and reads the error reason for positioning integrity.

In step 305: the LMF network element changes the positioning method of the terminal based on the error reason, or optimizes the positioning configuration of the terminal based on the error reason.

In some embodiments, after receiving the error reason for positioning integrity, the LMF network element can adjust the positioning strategy based on the error reason for positioning integrity.

For example, when the detected error source information reported by the UE is UE Rx-Tx timing difference, the LMF network element may not use multi-RTT positioning technology to perform positioning on the UE;

When the UE reports an error in the position of the TRP and/or time synchronization (NR-RTD-Info) between TRPs, the LMF network element can remove the TRP from the assistance information, that is, the subsequent positioning assistance information transmitted by the LMF network element to the UE does not include the TRP. Alternatively, the LMF uses multi-RTT positioning technology to perform positioning on the UE.

That is, when the error reason reported by the terminal includes the first information, the LMF network element can adjust the positioning method and not use the first information to perform positioning on the terminal, or the LMF network element can adjust the parameters related to the first information to correct the error caused by the first information.

In some embodiments, steps 301, 303, 304, and 305 can be implemented separately as one embodiment, or any of steps 301, 303, 304, and 305 can be recombined into a new embodiment.

In summary, the method provided in this embodiment allows the UE to report not only the positioning integrity alert or PL to the LMF network element when a positioning integrity alert occurs or PL does not satisfy the inequality in the scenario of downlink positioning or uplink-downlink combined positioning. In addition, the UE further reports the error reason for the positioning integrity to the LMF network element, informing the LMF network element of the cause of the positioning integrity alert or transmitting PL. After receiving the error reason, the LMF network element can adjust the positioning technology according to the error reason or optimize the positioning configuration using the error reason, thereby improving the positioning accuracy of the UE.

### 2. LMF Network Element-Based Positioning Integrity.

FIG. 9 shows a flowchart of a transmission method for positioning integrity provided by an embodiment of the present disclosure. The method can be performed by the terminal. The method includes step 510.

In step 510, an error reason for positioning integrity of the terminal transmitted by an LMF network element is received, where the error reason includes error information.

In some embodiments, before step 510, the LMF network element can receive assistance information reported by the terminal or access network device, and the positioning integrity of the terminal can be calculated based on the assistance information. If the positioning integrity alert of the terminal is determined, the error reason for the positioning integrity of the terminal is further determined, in order to transmit the positioning integrity alert and error reason to the terminal.

Positioning includes downlink positioning, uplink-downlink combined positioning, and uplink positioning. For example, the positioning technologies adopted include but are not limited to those based on DL-TDOA, DL-AOD, multi-RTT, UL-TDOA, or UL-AOA.

In some embodiments, the method provided in the embodiments of the present disclosure can be applied to downlink positioning or uplink-downlink combined positioning scenarios.

For downlink positioning or uplink-downlink combined positioning, the LMF network element transmits the error reason for positioning integrity to the terminal. In some embodiments, the LMF network element transmits the error reason to the terminal through the LPP (Long term Evolution Positioning Protocol) message, such as the message of the LPP request location information.

In some embodiments, the positioning integrity includes at least one of the following:
The confidence of the accuracy of the location information provided by the positioning system;
The ability to transmit effective alerts when the positioning system does not meet the predetermined operating conditions.

Where the positioning system is a system that performs the above-mentioned positioning, such as one or more of the LMF network element (core network device), the terminal, or the access network device. Location information is information or data related to location or positioning. In some embodiments, failure to meet the predetermined operating conditions includes a Protection Level (PL) greater than an Alert Limit (AL).

In some embodiments, positioning integrity includes PL. PL includes HPL and/or VPL.

The positioning integrity is determined based on PE, TIR, AL, and TTA.

In some embodiments, PL is determined by the first inequality. The first inequality includes a first probability being less than TIR, where the first probability is the probability that the duration of the terminal satisfying both the first condition and the second condition is longer than TTA, the first condition includes PE being greater than AL, and the second condition includes PL being less than or equal to AL.

That is, the first inequality includes:
Prob per unit of time [((PE>AL) & (PL<=AL)) for longer than TTA]<required TIR

When the LMF network element determines that PL does not satisfy the above inequality, the LMF network element issues a positioning integrity alert to the terminal or transmits PL to the terminal. At this point, there is an error in the positioning integrity of the terminal. The LMF network element determines the error reason for positioning integrity and transmits the LMF network element to the terminal. For example, the LMF network element determines error information that causes the significant positioning error (PE).

In some embodiments, the error reason includes: error information. The error reason includes the error information that causes the LMF network element to determine a positioning integrity alert; or the error reason includes the error information that causes the LMF network element to determine a protection level (PL) upon a positioning integrity alert; or the reason for the error includes the error information that caused the LMF network element to determine a PL and an achievable target integrity risk (TIR) upon a positioning integrity alert.

Error information includes at least one of the following:
measurement information of the terminal;
timing information of the terminal;
a beam received by the terminal;
a receiving antenna of the terminal;
a position of TRP;
time synchronization information between TRPs (NR-RTD-Info);
beam information of a downlink positioning reference signal (DL-PRS); or
a boresight direction of a downlink positioning reference signal.

Where the measurement information of the terminal includes the relevant data obtained by the terminal measurement. The timing information of the terminal includes the local clock information of the terminal. The beam received by the terminal includes relevant information about the beam transmitted by the access network device to the terminal. The receiving antenna of the terminal includes relevant information about the antenna used by the terminal to receive positioning reference signals. TRP is the TRP of the access network device that jointly performs the positioning process with the terminal. When multiple TRPs are jointly performing the positioning process with the terminal, the error information may include time synchronization information between any two TRPs among the multiple TRPs. DL-PRS/PRS is a reference signal transmitted by the access network device (TRP) to the terminal for downlink positioning. The terminal receives and measures DL-PRS to obtain downlink positioning measurement result, and reports the downlink positioning measurement result to the network device (LMF network element) to complete the downlink positioning process.

Where the measurement information of the terminal includes at least one of the following:
a terminal receive-transmit timing difference (UE Rx-Tx timing difference);
Reference Signal time Difference (RSTD);
Positioning Reference Signal-Reference Signal Received Power (PRS-RSRP);
Positioning Reference Signal-Reference Signal Received Power Path (PRS-RSRPP);
Positioning Reference Signal-Reference Signal Received Quality (PRS-RSRQ); or
Positioning Reference Signal-Signal to Interference plus Noise Ratio (PRS-SINR).

Where PRS-RSRPP is the RSRP of the PRS transmission path. For example, the path for the downlink positioning reference signal to be transmitted from TRP to the terminal includes direct path, refracted path, etc.

Where TRP can also be represented as an access network device, and the error information can include at least one of the following: measurement information of the terminal, timing information of the terminal, beam received by the terminal, receiving antenna of the terminal, position of the access network device, time synchronization information between access network devices (NR-RTD-Info), beam information of the downlink positioning reference signal (DL-PRS), and boresight direction of the downlink positioning reference signal.

In some embodiments, the error information can include any parameter information of the integrity parameters of the error sources shown in table 1.

In some embodiments, the error reason transmitted by the LMF network element can include at least one piece of error information. When the LMF network element detects multiple pieces of error information, each piece of error information corresponds to a weight coefficient, where the weight coefficient represents the contribution of the error information to the positioning integrity alert, PL, or achievable TIR.

FIG. 10 shows a flowchart of a transmission method for positioning integrity provided by an embodiment of the present disclosure. The method can be performed by the terminal. Based on the embodiment shown in FIG. 9, step 510 includes step 511.

In step 511, the error reason for the positioning integrity transmitted by the LMF network element is received, where the error reason includes at least one piece of error information and a weight coefficient corresponding to each piece of error information.

The terminal receives the error reason for positioning integrity transmitted by the LMF network element, where the error information includes at least one piece of error information and a weight coefficient corresponding to each piece of error information.

When there are pieces of error information detected by the LMF network element, the error reason further includes: the weight coefficient corresponding to each piece of error information; where the weight coefficient is configured to represent a contribution of a piece of error information to a positioning integrity alert, or the weight coefficient is configured to represent a contribution of a piece of error information to a PL, or the weight coefficient is configured to represent a contribution of a piece of error information to an achievable TIR.

That is, the error reason transmitted by LMF network element includes at least one piece of error information and a weight coefficient corresponding to each piece of error information.

In some embodiments, the weight coefficient can be a coefficient calculated in real-time based on the contribution of error information to this positioning integrity alert. The weight coefficient can also be a preset weight coefficient based on the degree of impact of error information on the calculating of the positioning integrity.

In some embodiments, the error reason transmitted by the LMF network element can further include the specific numerical value corresponding to the error information. For example, when the error reason includes the measurement information of the terminal, the measurement value corresponding to the measurement information can also be carried in the error reason. Then, the error reason includes at least the error information. In addition, the error reason can further include at least one of: a weight coefficient corresponding to the error information or a specific numerical value corresponding to the error information.

In summary, the method provided in this embodiment enables the LMF network element to transmit the error reason for the positioning integrity alert to the terminal in the scenario of LMF network element-based positioning integrity, such that the terminal knows the cause of the positioning integrity alert.

FIG. 11 shows a flowchart of a transmission method for positioning integrity provided by an embodiment of the present disclosure. The method can be performed by the LMF network element. The method includes step 520.

In step 520, the error reason for the positioning integrity of the terminal is transmitted, where the error reason includes the error information.

In the scenario of downlink positioning or uplink-downlink combined positioning, the LMF network element transmits the error reason for the positioning integrity of the terminal to the terminal and/or access network device.

In some embodiments, the LMF network element transmits the error reason for positioning integrity to the terminal through the LPP message. For example, the error reason is carried in the LPP request location information.

In some embodiments, the LMF network element transmits the error reason for positioning integrity of the terminal to the access network device through the message of NRPPa (NR Positioning Protocol A).

In some embodiments, the positioning integrity includes at least one of the following:
The confidence of the accuracy of the location information provided by the positioning system;
The ability to transmit effective alerts when the positioning system does not meet the predetermined operating conditions.

Where the positioning system is a system that performs the above-mentioned positioning, such as one or more of the LMF, the terminal, or the network device. Location information is information or data related to location or positioning. In some embodiments, failure to meet the predetermined operating conditions includes a Protection Level (PL) greater than an Alert Limit (AL).

In some embodiments, the positioning integrity includes at least one of the following:
The confidence of the accuracy of the location information provided by the positioning system;
The ability to transmit effective alerts when the positioning system does not meet the predetermined operating conditions.

Where the positioning system is a system that performs the above-mentioned positioning, such as one or more of the LMF network element (core network device), the terminal, or the access network device. Location information is information or data related to location or positioning. In some embodiments, failure to meet the predetermined operating conditions includes a Protection Level (PL) greater than an Alert Limit (AL).

In some embodiments, positioning integrity includes PL. PL includes HPL and/or VPL.

The positioning integrity is determined based on PE, TIR, AL, and TTA.

In some embodiments, PL is determined by the first inequality. The first inequality includes a first probability being less than TIR, where the first probability is the probability that the duration of the terminal satisfying both the first condition and the second condition is longer than TTA, the first condition includes PE being greater than AL, and the second condition includes PL being less than or equal to AL.

That is, the first inequality includes:
Prob per unit of time [((PE>AL) & (PL<=AL)) for longer than TTA]<required TIR

When the LMF network element determines that PL does not satisfy the above inequality, the LMF network element issues a positioning integrity alert to the terminal or transmits PL to the terminal. At this point, there is an error in the positioning integrity of the terminal. The LMF network element determines the error reason for positioning integrity and transmits the LMF network element to the terminal. For example, the LMF network element determines error information that causes the significant positioning error (PE).

In some embodiments, the error reason includes: error information. The error reason includes the error information that causes the LMF network element to determine a positioning integrity alert; or the error reason includes the error information that causes the LMF network element to determine a protection level (PL) upon a positioning integrity alert; or the reason for the error includes the error information that caused the LMF network element to determine a PL and an achievable target integrity risk (TIR) upon a positioning integrity alert.

Error information includes at least one of the following:
measurement information of the terminal;
timing information of the terminal;
a beam received by the terminal;
a receiving antenna of the terminal;
a position of TRP;
time synchronization information between TRPs (NR-RTD-Info);
beam information of a downlink positioning reference signal (DL-PRS); or
a boresight direction of a downlink positioning reference signal.

Where the measurement information of the terminal includes at least one of the following:
a terminal receive-transmit timing difference (UE Rx-Tx timing difference);
RSTD;
PRS-RSRP;
PRS-RSRPP;
PRS-RSRQ; or
PRS-SINR.

Where TRP can also be represented as an access network device, and the error information can include at least one of the following: measurement information of the terminal, timing information of the terminal, beam received by the terminal, receiving antenna of the terminal, position of the access network device, time synchronization information between access network devices (NR-RTD-Info), beam information of the downlink positioning reference signal (DL-PRS), and boresight direction of the downlink positioning reference signal.

In some embodiments, the error information can include any parameter information of the integrity parameters of the error sources shown in table 1.

In some embodiments, the error reason transmitted by the LMF network element can include at least one piece of error information. When the LMF network element detects multiple pieces of error information, each piece of error information corresponds to a weight coefficient, where the weight coefficient represents the contribution of the error information to the positioning integrity alert, PL, or achievable TIR.

FIG. 12 shows a flowchart of a transmission method for positioning integrity provided by an embodiment of the present disclosure. The method can be performed by the LMF network element. Based on the embodiment shown in FIG. 11, step 520 includes step 521.

In step 521, the error reason for positioning integrity of the terminal is transmitted, where the error information includes at least one piece of error information and a weight coefficient corresponding to each piece of error information.

The LMF network element transmits an error reason for positioning integrity to the terminal, where the error information includes at least one piece of error information and a weight coefficient corresponding to each piece of error information.

When there are pieces of detected error information, the error reason further includes: the weight coefficient corresponding to each piece of error information; where the weight coefficient is configured to represent a contribution of a piece of error information to a positioning integrity alert, or the weight coefficient is configured to represent a contribution of a piece of error information to a PL, or the weight coefficient is configured to represent a contribution of a piece of error information to an achievable TIR.

That is, the error reason transmitted by LMF network element includes at least one piece of error information and a weight coefficient corresponding to each piece of error information.

In some embodiments, the weight coefficient can be a coefficient calculated in real-time based on the contribution of error information to this positioning integrity alert. The weight coefficient can also be a preset weight coefficient based on the degree of impact of error information on the calculating of the positioning integrity.

In some embodiments, the error reason transmitted by the LMF network element can further include the specific numerical value corresponding to the error information. For example, when the error reason includes the measurement information of the terminal, the measurement value corresponding to the measurement information can also be carried in the error reason. Then, the error reason includes at least the error information. In addition, the error reason can further include at least one of: a weight coefficient corresponding to the error information or a specific numerical value corresponding to the error information.

In summary, the method provided in this embodiment enables the LMF network element to transmit the error reason for the positioning integrity alert to the terminal in the scenario of LMF network element-based positioning integrity, such that the terminal knows the cause of the positioning integrity alert.

FIG. 13 shows a flowchart of a transmission method for positioning integrity provided by an embodiment of the present disclosure. This method can be performed by the terminal, the access network device, and the LMF network element. The method includes steps 601 and 604.

In step 601, the terminal and the access network device perform downlink positioning or uplink-downlink combined positioning.

In some embodiments, during the process of performing downlink positioning or combining uplink and downlink positioning, the access network device (TRP) transmits a PRS to the terminal, and the terminal receives and measures the PRS to obtain the downlink positioning measurement result.

The LMF network element calculates the positioning integrity of the terminal based on the downlink positioning measurement result.

In step 604, the LMF network element transmits the error reason for positioning integrity to the terminal.

When there is a positioning integrity error, or when PL does not satisfy the inequality, or when a positioning integrity alert occurs, the LMF network element transmits the error information for positioning integrity to the terminal.

Where the detected error information is the error information that causes the LMF network element to transmit a positioning integrity alert, or the error information that causes the LMF network element to transmit a PL, or the error information that causes the LMF network element to transmit a PL and achievable TIR.

That is, the error reason includes: error information. The error reason includes the error information that causes the LMF network element to determine a positioning integrity alert; or the error reason includes the error information that causes the LMF network element to determine a protection level (PL) upon a positioning integrity alert; or the reason for the error includes the error information that caused the LMF network element to determine a PL and an achievable target integrity risk (TIR) upon a positioning integrity alert.

Error information includes at least one of the following:
measurement information of the terminal;
timing information of the terminal;
a beam received by the terminal;
a receiving antenna of the terminal;
a position of TRP;
time synchronization information between TRPs (NR-RTD-Info);
beam information of a downlink positioning reference signal (DL-PRS); or
a boresight direction of a downlink positioning reference signal.

Where the measurement information of the terminal includes at least one of the following:
a terminal receive-transmit timing difference (UE Rx-Tx timing difference);
RSTD;
PRS-RSRP;
PRS-RSRPP;
PRS-RSRQ; or
PRS-SINR.

Where TRP can also be represented as an access network device, and the error information can include at least one of the following: measurement information of the terminal, timing information of the terminal, beam received by the terminal, receiving antenna of the terminal, position of the access network device, time synchronization information between access network devices (NR-RTD-Info), beam information of the downlink positioning reference signal (DL-PRS), and boresight direction of the downlink positioning reference signal.

In some embodiments, the error reason for positioning integrity is carried in the LPP message, such as in the message of the LPP request location information. The LMF network element transmits an LPP message to the terminal, where the LPP message includes the error reason for the positioning integrity; and the terminal receives the LPP message and reads the error reason for positioning integrity.

In some embodiments, steps 601 and 604 can be implemented separately as one embodiment.

In summary, in the method provided in this embodiment, in the scenario of downlink positioning or uplink-downlink combined positioning, when a positioning integrity alert occurs or PL does not satisfy the inequality, the LMF network element transmits the error reason for positioning integrity to the terminal to inform the cause of the positioning integrity alert or the reason for transmitting PL.

FIG. 14 shows a flowchart of a transmission method for positioning integrity provided by an embodiment of the present disclosure. This method can be performed by the terminal, the access network device, and the LMF network element. The method includes steps 601, 603 and 604.

In step 601, the terminal and the access network device perform downlink positioning or uplink-downlink combined positioning.

The access network device transmits a downlink positioning signal, and the terminal receives and measures the downlink positioning signal to obtain the positioning measurement result. The terminal reports the positioning measurement result to the LMF network element.

In some embodiments, the positioning measurement result can be carried in the LPP message.

The LMF network element calculates the positioning integrity information of the terminal based on the positioning measurement result.

In step 603: the terminal transmits an error reason acquisition request to the LMF network element.

In some embodiments, when the terminal receives a positioning integrity alert or PL, the terminal can further transmit an error reason acquisition request to the LMF network element, requesting to obtain the error information that triggers the positioning integrity alert.

In some embodiments, the error reason acquisition request is carried in the LPP message. For example, the LPP message can be a message of an LPP request assistance data.

The terminal transmits an LPP message to the LMF network element, where the LPP message includes a request to obtain the error reason; and the LMF network element receives the LPP message transmitted by the terminal and reads the error reason to obtain the request.

In step 604, the LMF network element transmits the error reason for positioning integrity to the terminal.

In some embodiments, the LMF network element responds to the error reason acquisition request and transmits the error reason for positioning integrity to the terminal, where the error reason includes the detected error information.

Where the detected error information is an error information that causes the LMF network element to transmit a positioning integrity alert, or causes the LMF network element to transmit a PL, or causes the LMF network element to transmit a PL and achievable TIR.

That is, the error reason includes: error information. The error reason includes the error information that causes the LMF network element to determine a positioning integrity alert; or the error reason includes the error information that causes the LMF network element to determine a protection level (PL) upon a positioning integrity alert; or the reason for the error includes the error information that caused the LMF network element to determine a PL and an achievable target integrity risk (TIR) upon a positioning integrity alert.

Error information includes at least one of the following:
measurement information of the terminal;
timing information of the terminal;
a beam received by the terminal;
a receiving antenna of the terminal;
a position of TRP;
time synchronization information between TRPs (NR-RTD-Info);
beam information of a downlink positioning reference signal (DL-PRS); or
a boresight direction of a downlink positioning reference signal.

Where the measurement information of the terminal includes at least one of the following:
a terminal receive-transmit timing difference (UE Rx-Tx timing difference);
RSTD;
PRS-RSRP;
PRS-RSRPP;
PRS-RSRQ; or
PRS-SINR.

Where TRP can also be represented as an access network device, and the error information can include at least one of the following: measurement information of the terminal, timing information of the terminal, beam received by the terminal, receiving antenna of the terminal, position of the access network device, time synchronization information between access network devices (NR-RTD-Info), beam information of the downlink positioning reference signal (DL-PRS), and boresight direction of the downlink positioning reference signal.

In some embodiments, the error reason for positioning integrity is carried in the LPP message, such as in the message of the LPP request location information. The LMF network element transmits an LPP message to the terminal, where the LPP message includes the error reason for the positioning integrity; and the terminal receives the LPP message and reads the error reason for positioning integrity.

In some embodiments, steps 601, 603, and 604 can be implemented separately as one embodiment, or any of steps 601, 603, and 604 can be recombined into a new embodiment.

In summary, in the method provided in this embodiment, in the scenario of downlink positioning or uplink-downlink combined positioning, the LMF network element can respond to the error reason acquisition request transmitted by the UE when a positioning integrity alert occurs or PL does not satisfy the inequality, to transmit the error reason of positioning integrity to the UE to inform the cause of the positioning integrity alert or PL transmission.

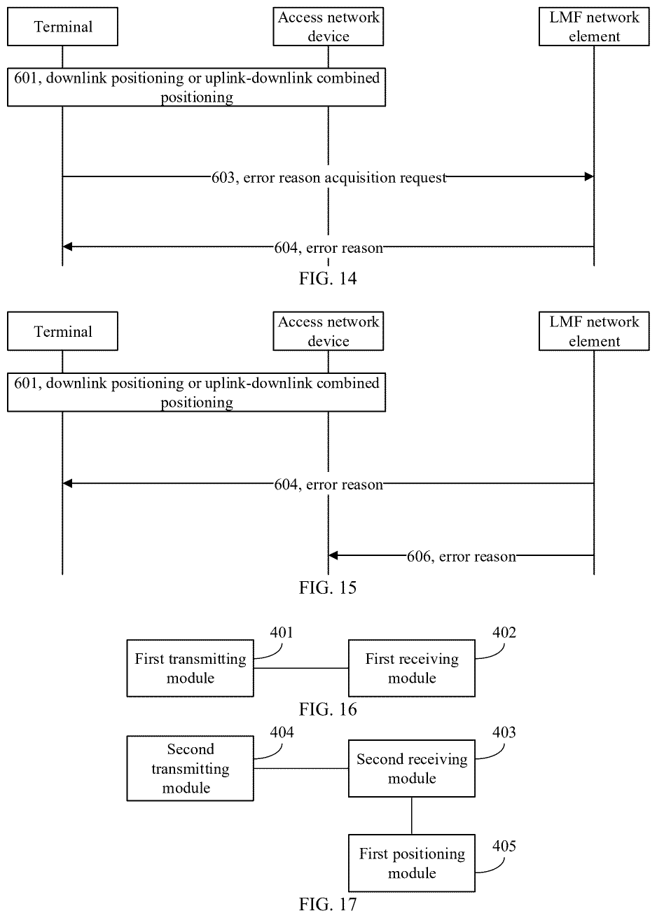

FIG. 15 shows a flowchart of a transmission method for positioning integrity provided by an embodiment of the present disclosure. This method can be performed by the terminal, the access network device, and the LMF network element. The method includes steps 601, 604 and 606.

In step 601, the terminal and the access network device perform downlink positioning or uplink-downlink combined positioning.

The access network device transmits a downlink positioning signal, and the terminal receives and measures the downlink positioning signal to obtain the positioning measurement result. The terminal reports the positioning measurement result to the LMF network element.

In some embodiments, the positioning measurement result can be carried in the LPP message.

The LMF network element calculates the positioning integrity information of the terminal based on the positioning measurement result.

In step 604, the LMF network element transmits the error reason for positioning integrity to the terminal.

In some embodiments, the LMF network element can actively transmit the error reason for positioning integrity to the terminal when a positioning integrity alert occurs. The LMF network element can also respond to the error reason acquisition request transmitted by the terminal to transmit the error reason for positioning integrity to the terminal, where the error reason includes the detected error information.

Where the detected error information is an error information that causes the LMF network element to transmit a positioning integrity alert, or causes the LMF network element to transmit a PL, or causes the LMF network element to transmit a PL and achievable TIR.

That is, the error reason includes: error information. The error reason includes the error information that causes the LMF network element to determine a positioning integrity alert; or the error reason includes the error information that causes the LMF network element to determine a protection level (PL) upon a positioning integrity alert; or the reason for the error includes the error information that caused the LMF network element to determine a PL and an achievable target integrity risk (TIR) upon a positioning integrity alert.

Error information includes at least one of the following:
measurement information of the terminal;
timing information of the terminal;
a beam received by the terminal;
a receiving antenna of the terminal;
a position of TRP;
time synchronization information between TRPs (NR-RTD-Info);
beam information of a downlink positioning reference signal (DL-PRS); or
a boresight direction of a downlink positioning reference signal.

Where the measurement information of the terminal includes at least one of the following:
a terminal receive-transmit timing difference (UE Rx-Tx timing difference);
RSTD;
PRS-RSRP;
PRS-RSRPP;
PRS-RSRQ; or
PRS-SINR.

Where TRP can also be represented as an access network device, and the error information can include at least one of the following: measurement information of the terminal, timing information of the terminal, beam received by the terminal, receiving antenna of the terminal, position of the access network device, time synchronization information between access network devices (NR-RTD-Info), beam information of the downlink positioning reference signal (DL-PRS), and boresight direction of the downlink positioning reference signal.

In some embodiments, the error reason for positioning integrity is carried in the LPP message, such as in the message of the LPP request location information. The LMF network element transmits an LPP message to the terminal, where the LPP message includes the error reason for the positioning integrity; and the terminal receives the LPP message and reads the error reason for positioning integrity.

In step 606, the LMF network element transmits the error reason for the positioning integrity of the terminal to the access network device.

In some embodiments, the error reason transmitted by the LMF network element to the access network device is carried in the NRPPa message.

In some embodiments, the error reasons in steps 604 and 606 can be the same or partially the same or different.

In some embodiments, when the two error reason are different, the LMF network element can transmit the terminal related error reason to the terminal. Such as measurement information of the terminal, timing information of the terminal, receiving antenna of the terminal, etc. The LMF network element can transmit the access network device related error reason to the access network device, such as the beams received by the terminal, the position of TRP, and time synchronization information between TRPs.

In some embodiments, if the terminal and access network device can spontaneously correct the error reason after receiving the error reason, the terminal and access network device can correct the information corresponding to the error information based on the error reason.

In some embodiments, steps 601, 604, and 606 can be implemented separately as one embodiment, or any of steps 601, 604, and 606 can be recombined into a new embodiment.

In summary, in the method provided in this embodiment, in the scenario of downlink positioning or uplink-downlink combined positioning, when a positioning integrity alert occurs or PL does not satisfy the inequality, the error reason for positioning integrity is transmitted to the UE and access network device, to inform the UE and access network device of the cause of the positioning integrity alert or PL transmitting, and facilitate the adjustment of relevant parameters by the UE and access network device, thereby improving positioning accuracy.

It should be noted that the order of the method steps provided in the embodiments of the present disclosure can be appropriately adjusted, and a step can be added or removed according to the situation, and different steps can be freely combined to form new embodiments. For example, steps 301, 302, 303, 304, and 305 can be combined into a new embodiment, or any of steps 301, 302, 303, 304, and 305 can be recombined into a new embodiment. For example, steps 601, 603, 604, and 606 can be combined into a new embodiment, or any of steps 601, 603, 604, and 606 can be recombined into a new embodiment. Any variation of method readily conceivable by a person skilled in the art within the technical scope disclosed in the present disclosure should belong to the scope of protection of the present disclosure, and therefore will not be repeated.

FIG. 16 shows the structural block diagram of a positioning integrity transmission apparatus provided by an embodiment of the present disclosure. As shown in FIG. 16, the apparatus includes:
a first transmitting module 401, configured to transmit an error reason for positioning integrity, where the error reason includes error information.

In an embodiment, the error reason includes the error information that causes the terminal to transmit a positioning integrity alert; or
the error reason includes the error information that causes the terminal to transmit a protection level (PL); or
the error reason includes the error information that causes the terminal to transmit a PL and an achievable TIR.

In an embodiment, the error information includes at least one of the following:
measurement information of the terminal;
timing information of the terminal;
a beam received by the terminal;
a receiving antenna of the terminal;
a position of transmit/receive point (TRP);
time synchronization information between TRPs;
beam information of a downlink positioning reference signal; or
a boresight direction of a downlink positioning reference signal.

In an embodiment, the measurement information of the terminal includes at least one of the following:
a terminal receive-transmit timing difference;
reference signal time difference (RSTD);
positioning reference signal-reference signal received power (PRS-RSRP);
positioning reference signal-reference signal received power path (PRS-RSRPP);
positioning reference signal-reference signal received quality (PRS-RSRQ); or positioning reference signal-signal to interference plus noise ratio (PRS-SINR).

In an embodiment, in a case where there are pieces of the detected error information, the error reason further includes: a weight coefficient corresponding to each of the pieces of the error information;
where the weight coefficient is configured to represent a contribution of a piece of error information to a positioning integrity alert, or the weight coefficient is configured to represent a contribution of a piece of error information to a PL, or the weight coefficient is configured to represent a contribution of a piece of error information to an achievable TIR.

In an embodiment, the apparatus further includes:
The first receiving module 402 is configured to receive an error reason acquisition request, where the error reason acquisition request is configured to request the terminal to report the error reason for positioning integrity.

FIG. 17 shows the structural block diagram of a positioning integrity transmission apparatus provided by an embodiment of the present disclosure. As shown in FIG. 17, the apparatus includes:
a second receiving module 403, configured to receive an error reason for positioning integrity of a terminal, where the error reason includes error information.

In an embodiment, the error reason includes the error information that causes the terminal to transmit a positioning integrity alert; or
the error reason includes the error information that causes the terminal to transmit a protection level (PL); or
the error reason includes the error information that causes the terminal to transmit a PL and an achievable TIR.

In an embodiment, the error information includes at least one of the following:
measurement information of the terminal;
timing information of the terminal;
a beam received by the terminal;
a receiving antenna of the terminal;
a position of transmit/receive point (TRP);
time synchronization information between TRPs;
beam information of a downlink positioning reference signal; or
a boresight direction of a downlink positioning reference signal.

In an embodiment, the measurement information of the terminal includes at least one of the following:
a terminal receive-transmit timing difference;
reference signal time difference (RSTD);
positioning reference signal-reference signal received power (PRS-RSRP);
positioning reference signal-reference signal received power path (PRS-RSRPP);
positioning reference signal-reference signal received quality (PRS-RSRQ); or
positioning reference signal-signal to interference plus noise ratio (PRS-SINR).

In an embodiment, in a case where there are pieces of the error information detected by the terminal, the error reason further includes: a weight coefficient corresponding to each of the pieces of the error information;
where the weight coefficient is configured to represent a contribution of a piece of error information to a positioning integrity alert, or the weight coefficient is configured to represent a contribution of a piece of error information to a PL, or the weight coefficient is configured to represent a contribution of a piece of error information to an achievable TIR.

In an embodiment, the apparatus further includes:

The second transmitting module 404 is configured to transmit an error reason acquisition request to the terminal, where the error reason acquisition request is configured to request the terminal to report the error reason for positioning integrity.

In an embodiment, the apparatus further includes:
The first positioning module 405 is configured to change a positioning method for the terminal based on the error reason; or
optimize a positioning configuration for the terminal based on the error reason.

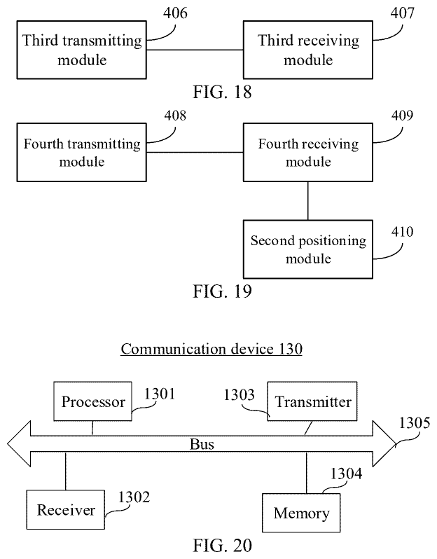

FIG. 18 shows the structural block diagram of a positioning integrity transmission apparatus provided by an embodiment of the present disclosure. As shown in FIG. 18, the apparatus includes:
a third receiving module 407, configured to receive an error reason for positioning integrity of a terminal transmitted by an LMF network element, where the error reason includes error information.

In an embodiment, the error reason includes the error information that caused the LMF network element to determine the positioning integrity alert; or
the error reason includes the error information that causes the LMF network element to determine a protection level (PL) upon a positioning integrity alert; or
the reason for the error includes the error information that caused the LMF network element to determine a PL and an achievable target integrity risk (TIR) upon a positioning integrity alert.

In an embodiment, the error information includes at least one of the following: measurement information of the terminal;
timing information of the terminal;
a beam received by the terminal;
a receiving antenna of the terminal;
a position of transmit/receive point (TRP);
time synchronization information between TRPs;
beam information of a downlink positioning reference signal; or
a boresight direction of a downlink positioning reference signal.

In an embodiment, the measurement information of the terminal includes at least one of the following:
a terminal receive-transmit timing difference;
reference signal time difference (RSTD);
positioning reference signal-reference signal received power (PRS-RSRP);
positioning reference signal-reference signal received power path (PRS-RSRPP);
positioning reference signal-reference signal received quality (PRS-RSRQ); or
positioning reference signal-signal to interference plus noise ratio (PRS-SINR).

In an embodiment, in a case where there are pieces of the error information detected by the LMF network element, the error reason further includes: a weight coefficient corresponding to each of the pieces of the error information;
where the weight coefficient is configured to represent a contribution of a piece of error information to a positioning integrity alert, or the weight coefficient is configured to represent a contribution of a piece of error information to a PL, or the weight coefficient is configured to represent a contribution of a piece of error information to an achievable TIR.

In an embodiment, the apparatus further includes:

The third transmitting module 406 is configured to transmit an error reason acquisition request, where the acquisition request is configured to request the LMF network element to provide the error reason for positioning integrity.

FIG. 19 shows the structural block diagram of a positioning integrity transmission apparatus provided by an embodiment of the present disclosure. As shown in FIG. 19, the apparatus includes:
a fourth transmitting module 408, configured to transmit an error reason for positioning integrity of a terminal, where the error reason includes error information.

In an embodiment, the error reason includes the error information that caused the LMF network element to determine the positioning integrity alert; or
the error reason includes the error information that causes the LMF network element to determine a protection level (PL) upon a positioning integrity alert; or
the reason for the error includes the error information that caused the LMF network element to determine a PL and an achievable target integrity risk (TIR) upon a positioning integrity alert.

In an embodiment, the error information includes at least one of the following:
measurement information of the terminal;
timing information of the terminal;
a beam received by the terminal;
a receiving antenna of the terminal;
a position of transmit/receive point (TRP);
time synchronization information between TRPs;
beam information of a downlink positioning reference signal; or
a boresight direction of a downlink positioning reference signal.

In an embodiment, the measurement information of the terminal includes at least one of the following:
a terminal receive-transmit timing difference;
reference signal time difference (RSTD);
positioning reference signal-reference signal received power (PRS-RSRP);
positioning reference signal-reference signal received power path (PRS-RSRPP);
positioning reference signal-reference signal received quality (PRS-RSRQ); or
positioning reference signal-signal to interference plus noise ratio (PRS-SINR).

In an embodiment, in a case where there are pieces of the detected error information, the error reason further includes: a weight coefficient corresponding to each of the pieces of the error information;
where the weight coefficient is configured to represent a contribution of a piece of error information to a positioning integrity alert, or the weight coefficient is configured to represent a contribution of a piece of error information to a PL, or the weight coefficient is configured to represent a contribution of a piece of error information to an achievable TIR.

In an embodiment, the apparatus further includes:
a fourth receiving module 409, configured to receive an error reason acquisition request, where the error reason acquisition request is configured to request obtaining the error reason for positioning integrity of the terminal.

In an embodiment, the apparatus further includes:
a second positioning module 410, configured to change a positioning method for the terminal based on the error reason; or
optimize a positioning configuration for the terminal based on the error reason.

In an embodiment, the fourth transmitting module 408 is configured to transmit the error reason for positioning integrity of the terminal to the terminal.

In an embodiment, the fourth transmitting module 408 is configured to transmit the error reason for positioning integrity of the terminal to an access network device.

It should be noted that when the apparatus provided in the above mentioned embodiments implement the function, the apparatus is divided into functional modules as an example for illustration. In practical applications, the above-mentioned functions can be completed by different functional modules according to needs, that is, the internal structure of a device is divided into different functional modules, so as to complete all or part of the above functions.

Regarding the apparatuses in the above examples, the specific manner in which each module performs operations has been described in detail in the examples of the methods, and will not be described in detail here.

FIG. 20 is a structural schematic diagram of a communication device provided in an embodiment of the present disclosure. The communication device 130 includes a processor 1301, a receiver 1302, a transmitter 1303, a memory 1304, and a bus 1305.

The processor 1301 includes one or more processing cores, the processor 1301 executes various functional applications and information processing by running software programs and modules.

The receiver 1302 and the transmitter 1303 can be implemented as a communication component, and the communication component can be a communication chip.

The memory 1304 is connected to the processor 1301 through the bus 1305.

The memory 1304 can be used to store at least one instruction, and the processor 1301 is configured to execute the at least one instruction to implement the various steps in the above method embodiments.

In addition, the memory 1304 can be implemented by any type of volatile or non-volatile storage device or combination thereof, including but not limited to: magnetic or optical disks, electrically erasable programmable read only memory (EEPROM), erasable programmable read only memory (EPROM), static random access memory (SRAM), read only memory (ROM), magnetic storage, flash memory, or programmable read only memory (PROM).

When the communication device is implemented as a terminal, the processor and transceiver involved in the embodiments of the present disclosure can be implemented together as one communication chip, or the transceiver can form a separate communication chip. Where the transmitter in the transceiver performs the transmitting step performed by the terminal in any one of the methods shown above, the receiver in the transceiver performs the receiving step performed by the terminal in any one of the methods shown above, and the processor performs steps other than the transmitting and receiving steps, which will not be repeated here.

Where when the communication device is implemented as an LMF network element, the processor and transceiver in the communication device involved in the embodiments of the present disclosure can be implemented together as one communication chip, or the transceiver can form a separate communication chip. Where the transmitter in the transceiver performs the transmitting step performed by the LMF network element in any one of the methods shown above, the receiver in the transceiver performs the receiving step performed by the LMF network element in any one of the methods shown above, and the processor performs steps other than the transmitting and receiving steps, which will not be repeated here.

When the communication device is implemented as an access network device, the processor and transceiver involved in the embodiments of the present disclosure can be implemented together as one communication chip, or the transceiver can form a separate communication chip. Where the transmitter in the transceiver performs the transmitting step performed by the access network device in any one of the methods shown above, the receiver in the transceiver performs the receiving step performed by the access network device in any one of the methods shown above, and the processor performs steps other than the transmitting and receiving steps, which will not be repeated here.

In an embodiment, a computer-readable storage medium is further provided, which stores at least one instruction, at least one program, a code set, or an instruction set. The at least one instruction, the at least one program, the code set, or the instruction set is loaded and executed by a processor to implement the transmission method of positioning integrity provided by the various method embodiments described above.

In the embodiment, a chip is further provided, including programmable logic circuits and/or program instructions, where the chip is run on a communication device, to implement the transmission method of positioning integrity provided by the various method embodiments described above.

In an embodiment, a computer program product is further provided that, when run on a processor of a computer device, causes the computer device to perform the above-mentioned transmission method of positioning integrity.

Those skilled in the art should be aware that in one or more of the above examples, the functions described in the embodiments of the present disclosure can be implemented using hardware, software, firmware, or any combination thereof. When implemented using software, these functions can be stored on computer-readable media or transmitted as one or more instructions or code on computer-readable media. Computer readable media includes computer storage media and communication media, where communication media include any medium that facilitates the transmitting of computer programs from one position to another. Storage media can be any available medium that can be accessed by general-purpose or special-purpose computers.

The above embodiments provided in the present disclosure are not intended to limit the present disclosure. Any modifications, equivalent replacements, improvements, etc. made within the spirit and principles of the present disclosure shall be included in the scope of protection of the present disclosure.

1. A method for transmission positioning integrity, performed by a terminal, the method comprising:
transmitting an error reason for positioning integrity, wherein the error reason comprises error information.

2. The method according to claim 1, wherein
the error reason comprises the error information that causes the terminal to transmit a positioning integrity alert; or
the error reason comprises the error information that causes the terminal to transmit a protection level (PL); or
the error reason comprises the error information that causes the terminal to transmit a PL and an achievable target integrity risk (TIR).

3. The method according to claim 1, wherein the error information comprises at least one of:
measurement information of the terminal;
timing information of the terminal;
a beam received by the terminal;
a receiving antenna of the terminal;
a position of transmit/receive point (TRP);
time synchronization information between TRPs;
beam information of a downlink positioning reference signal; or
a boresight direction of a downlink positioning reference signal.

4. The method according to claim 3, wherein the measurement information of the terminal comprises at least one of:
a terminal receive-transmit timing difference;
reference signal time difference (RSTD);
positioning reference signal-reference signal received power (PRS-RSRP);
positioning reference signal-reference signal received power path (PRS-RSRPP);
positioning reference signal-reference signal received quality (PRS-RSRQ); or
positioning reference signal-signal to interference plus noise ratio (PRS-SINR).

5. The method according to claim 1, wherein, in a case where there are pieces of the detected error information, the error reason further comprises: a weight coefficient corresponding to each of the pieces of the error information;
wherein the weight coefficient is configured to represent a contribution of a piece of error information to a positioning integrity alert, or the weight coefficient is configured to represent a contribution of a piece of error information to a PL, or the weight coefficient is configured to represent a contribution of a piece of error information to an achievable TIR.

6. The method according to claim 1, further comprising:
receiving an error reason acquisition request, wherein the error reason acquisition request is configured to request the terminal to report the error reason for positioning integrity.

7. A method for transmission positioning integrity, performed by an Location Management Function (LMF) network element, comprising:
receiving an error reason for positioning integrity of a terminal, wherein the error reason comprises error information.

8. The method according to claim 7, wherein the error reason comprises the error information that causes the terminal to transmit a positioning integrity alert; or
the error reason comprises the error information that causes the terminal to transmit a protection level (PL); or
the error reason comprises the error information that causes the terminal to transmit a PL and an achievable target integrity risk (TIR).

9.-10. (canceled)

11. The method according to claim 7, wherein, in a case where there are pieces of the error information detected by the terminal, the error reason further comprises: a weight coefficient corresponding to each of the pieces of the error information;
wherein the weight coefficient is configured to represent a contribution of a piece of error information to a positioning integrity alert, or the weight coefficient is configured to represent a contribution of a piece of error information to a PL, or the weight coefficient is configured to represent a contribution of a piece of error information to an achievable TIR.

12. The method according to claim Z, further comprising:
transmitting an error reason acquisition request to the terminal, wherein the error reason acquisition request is configured to request the terminal to report the error reason for positioning integrity.

13. The method according to claim Z, further comprising:
changing a positioning method for the terminal based on the error reason; or
optimizing a positioning configuration for the terminal based on the error reason.

14. A method for transmission positioning integrity, performed by a terminal, the method comprising:
receiving an error reason for positioning integrity of the terminal transmitted by an LMF network element, wherein the error reason comprises error information.

15. The method according to claim 14, wherein
the error reason comprises the error information that causes the LMF network element to determine a positioning integrity alert; or
the error reason comprises the error information that causes the LMF network element to determine a protection level (PL) upon a positioning integrity alert; or
the error reason comprises the error information that caused the LMF network element to determine a PL and an achievable target integrity risk (TIR) upon a positioning integrity alert.

16. The method according to claim 14 or 15, wherein the error information comprises at least one of:
measurement information of the terminal;
timing information of the terminal;
a beam received by the terminal;
a receiving antenna of the terminal;
a position of transmit/receive point (TRP);
time synchronization information between TRPs;
beam information of a downlink positioning reference signal; or
a boresight direction of a downlink positioning reference signal.

17. (canceled)

18. The method according to claim 14, wherein, in a case where there are pieces of the error information detected by the LMF network element, the error reason further comprises: a weight coefficient corresponding to each of the pieces of the error information;
wherein the weight coefficient is configured to represent a contribution of a piece of error information to a positioning integrity alert, or the weight coefficient is configured to represent a contribution of a piece of error information to a PL, or the weight coefficient is configured to represent a contribution of a piece of error information to an achievable TIR.

19. The method according to claim 14, further comprising:
transmitting an error reason acquisition request, wherein the acquisition request is configured to request the LMF network element to provide the error reason for positioning integrity.

20.-31. (canceled)

32. A communication device, comprising:
one or more processors;
a transceiver connected to the one or more processors; and
one or more memories storing instructions executable by the one or more processors;
wherein the executable instructions when collectively executed by the one or more processors cause the communication device to act as the terminal and perform the method according to claim 1.

33. A communication device, comprising:
one or more processors;
a transceiver connected to the one or more processors;
one or more memories storing instructions executable by the one or more processors;
wherein the executable instructions when collectively executed by the one or more processors cause the communication device act as the LMF network element and perform the method according to claim 7.

34. A non-transitory computer-readable storage medium, wherein the computer-readable storage medium stores executable instructions, and the executable instructions when collectively executed by one or more processors of the terminal, cause the terminal to perform the method according to claim 1.

35. A chip of the terminal, the chip comprising:
programmable logic circuits and/or program instructions, wherein the chip is configured to perform the method to claim 1.

36. (canceled)
